(19) United States
(12) Patent Application Publication
(10) Pub. No.: US 2023/0254647 A1
(43) Pub. Date: Aug. 10, 2023

(54) ELECTRODYNAMIC TRANSDUCER

(71) Applicant: TREVES AUDIO, Reims (FR)

(72) Inventor: Jean-Philippe THOME, Clermont-Ferrand (FR)

(21) Appl. No.: 18/015,100

(22) PCT Filed: Jul. 8, 2021
(86) PCT No.: PCT/EP2021/069063

§ 371 Date: Jan. 9, 2023

(30) Foreign Application Priority Data
Jul. 9, 2020 (FR) 2007289

(51) Int. Cl. H04R 9/02; H04R 9/04; H04R 9/06; H04R 1/02

(52) U.S. Cl. CPC H04R 9/025; H04R 9/043; H04R 9/06; H04R 1/025; H04R 2400/11; H04R 2499/13; H04R 2400/07

(57) ABSTRACT

The invention relates to an electrodynamic transducer having a magnetic mass connected to a frame with first and second axially offset suspensions. The suspensions permit translational displacement of the magnetic mass with respect to the frame and have multiple springs. The direction of orientation of the springs of the first suspension is opposite that of the springs of the second suspension, such that each suspension blocks the axial rotation of the other suspension.

### CROSS-REFERENCE TO RELATED APPLICATIONS

This application claims the benefit of International application number PCT/EP2021/069063, filed Jul. 8, 2021 and French patent application number FR2007289, filed on Jul. 9, 2020, the entire contents of which are incorporated herein by reference.

### TECHNICAL FIELD

The present invention relates to an electrodynamic transducer and a trim element of a motor vehicle compartment provided with such a transducer.

### BACKGROUND

For the record, the transduction is the operation allowing transforming a physical quantity into another, this by means of a transducer which transforms the energy received in a given form, for example an electrical energy, into a usable energy in a different form, for example acoustic.

Within the scope of the invention, it is intended to transform an electrical signal into an acoustic signal by using, as radiation surface, the wall of the object on which the transducer is fastened.

A trim element, as mentioned above, is for example a window post cabinetwork, a covering panel of a luggage compartment, an under-seat carpet, a headliner, a door trim, etc.

In a known manner, an electrodynamic transducer comprises:
a fixed portion comprising a frame provided with a hollow mandrel fitting into a cylindrical envelope extending along an axis of symmetry, a coil being wound around said mandrel,
a movable portion comprising a magnetic mass, said mass comprising:
   a cylindrical metal part defining a housing,
   a hollow cylinder-shaped annular permanent magnet fastened into said cylindrical part and surrounding said coil,
   a cylindrical soft-iron core fastened on said cylindrical part and being inserted inside said mandrel, said coil being positioned in the air gap formed between said magnet and said core,

said magnetic mass being connected to said frame via first and second axially offset suspension means, said means allowing an axial translational displacement of the mass with respect to said frame.

For the acoustic signal to correspond faithfully to the received electrical signal, the movement of the magnetic mass should be solely an axial translational movement, that is to say along the axis of symmetry mentioned above.

However, it turns out that the axial translation of the magnetic mass can be accompanied by parasitic rotational movements which generate a distortion of the acoustic signal, resulting in a loss of quality in its restitution.

### SUMMARY OF THE INVENTION

It is this drawback that the invention proposes to overcome by proposing a transducer whose displacement of the magnetic mass can only be done in axial translation.

To this end, and according to a first aspect, the invention relates to an electrodynamic transducer comprising:
a fixed portion comprising a frame provided with a hollow mandrel fitting into a cylindrical envelope extending along an axis of symmetry, a coil being wound around said mandrel,
a movable portion comprising a magnetic mass, said mass
comprising:
a cylindrical metal part defining a housing,

a hollow cylinder-shaped annular permanent magnet fastened into said cylindrical part and surrounding said coil,
a cylindrical soft-iron core fastened on said cylindrical part and being inserted inside said mandrel, said coil being positioned in the air gap formed between said magnet and said core,
   said magnetic mass being connected to said frame via first and second axially offset suspension means, said means allowing an axial translational displacement of said mass with respect to said frame, said transducer further having the following characteristics:

each of said suspension means has a plurality of basic springs, said springs being disposed according to rotational symmetry about said axis between an inner portion of said means which is secured to said magnetic mass and an outer portion of said means which is secured to said frame, said portions being movable relative to each other in axial translation via said basic springs,

said basic springs comprise an inner segment and an outer segment, said segments extending along two concentric circular arcs about said axis and being separated by a slot, said segments having two respective first ends connected via a connecting bridge, said inner segment being secured via a second end to said inner portion and said outer segment having another second end which is secured to said outer portion, the path going from said second ends to said connecting bridge defining a direction of orientation of said basic springs,

the direction of orientation of said basic springs of said first suspension means is opposite to that of said basic springs of said second suspension means, such that each of said suspension means blocks axial rotation of the other of said suspension means.

It is recalled that the term “axial rotation” means a rotation about the axis of symmetry mentioned above.

The term “radially” is also taken with reference to the axis of symmetry mentioned above.

The invention allows, by the use of suspension means thus arranged, having a suspended magnetic mass which can only move in axial translation.

And any parasitic axial rotation is prevented by the “antagonistic” action of the suspension means whose basic springs are oppositely directed.

The impossibility of axial rotational movement of the magnetic mass guarantees an optimal restitution of the sound signal.

According to a second aspect, the invention relates to a trim element of a motor vehicle compartment provided with such a transducer.

### BRIEF DESCRIPTION OF THE DRAWINGS

The invention will be better understood and other advantages thereof will appear on reading the following description, made with reference to the appended figures in which:

FIG. 1 is a schematic sectional view according to one embodiment of a transducer in a pre-assembly configuration on a wall,

FIG. 2 is an axial view of a suspension means according to one embodiment,

FIG. 3 is a perspective view of two suspension means similar to that of FIG. 2 as positioned in the transducer of FIG. 1,

FIG. 4 is a schematic axial view, according to one embodiment, of a ring for adjusting the stiffness of a suspension means in interaction with the suspension means of FIGS. 2 and 3,

FIG. 5 is a schematic sectional view of the transducer of FIG. 1 provided with an adjustment ring as illustrated in FIG. 4,

FIG. 6 is a partial perspective principle view of an adjustment ring interacting with a basic spring according to one embodiment,

FIG. 7 is a schematic perspective view of a basic spring according to one embodiment,

FIG. 8 is similar to FIG. 1, the transducer being mounted on the wall.

### DETAILED DESCRIPTION

With reference to the figures, an electrodynamic transducer 1 is described according to one embodiment, said transducer comprising:
a fixed portion comprising a frame 5—in particular made of moulded plastic material—provided with a hollow mandrel 8 fitting into a cylindrical envelope extending along an axis of symmetry A, a coil 9 being wound around said mandrel,
   a movable portion comprising a magnetic mass 11, said mass comprising:
   a cylindrical metal part 14—for example made of soft iron—defining a housing,
a hollow cylinder-shaped annular permanent magnet 13 fastened into said cylindrical part and surrounding said coil,
   a cylindrical soft-iron core 12 fastened on said cylindrical part and being inserted inside said mandrel, said coil being positioned in the air gap 10 formed between said magnet and said core,
      said magnetic mass being connected to said frame via first 19a and second 19b axially offset suspension means 19, said means allowing an axial translational displacement of said mass with respect to said frame, said transducer further having the following characteristics:

each of said suspension means has a plurality of basic springs 25, said springs being disposed according to rotational symmetry about said axis between an inner portion 22 of said means which is secured to said magnetic mass and an outer portion 24 of said means which is secured to said frame, said portions being movable relative to each other in axial translation via said basic springs,

said basic springs comprise an inner segment 26 and an outer segment 27, said segments extending along two concentric circular arcs about said axis and being separated by a slot 28, said segments having two respective first ends 30, 31 connected via a connecting bridge 29, said inner segment being secured via a second end 32 to said inner portion and said outer segment having another second end 33 which is secured to said outer portion, the path going from said second ends to said connecting bridge defining a direction of orientation S1, S2 of said basic springs,

the direction of orientation S1 of said basic springs of said first suspension means is opposite to that S2 of said basic springs of said second suspension means, such that each of said suspension means blocks axial rotation of the other of said suspension means.

According to the represented embodiment, at least one and in particular the two inner 22 and outer 24 portions are annular.

In order to achieve an isostatic system, provision should be made for the suspension means 19a, 19b to be provided with at least three basic springs 25—said means being in particular provided with four of said springs according to the represented embodiment.

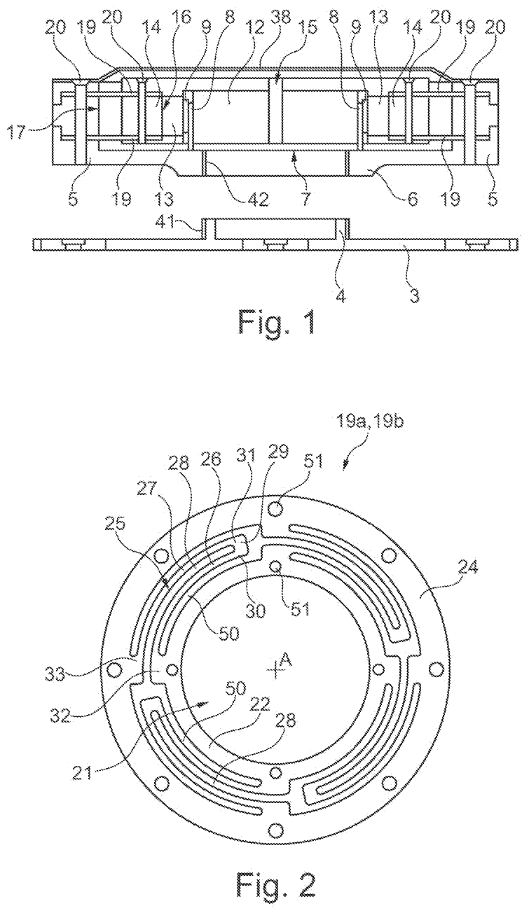

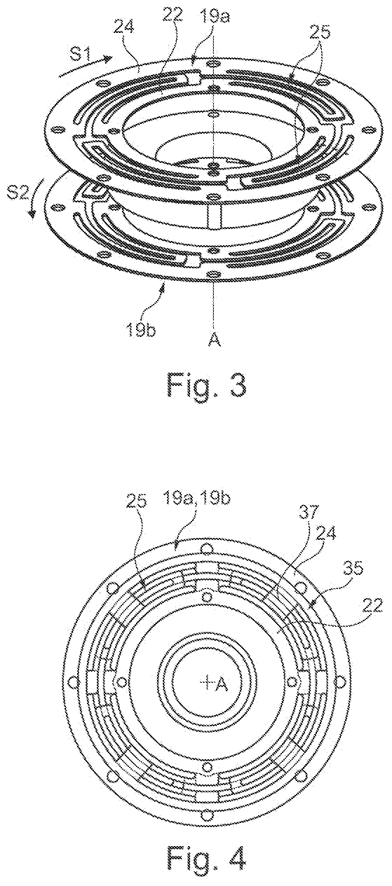

More specifically, FIG. 1 is a representation of a transducer 1, in accordance with one embodiment of the invention, in position on a wall 2.

Here, the fastening on the wall 2 of the transducer 1 is performed, preferably in a removable manner, using a base 3.

The base 3 is itself secured to the wall 2 in a permanent or removable manner.

For this, the base 3 is provided with at least one fastening member, for example an adhesive area, a magnet, bores for passing screws or spikes.

In order to receive the actual transducer 1, the base 3 comprise means for fastening the transducer 1.

Here, it is a cylindrical relief 4 provided with a thread 41 on the outer face thereof—or its inner face according to a variant which is not represented.

According to an alternative embodiment which is not represented, the fastening means is a clip.

As shown in FIGS. 1 and 2, the transducer 1 extends above the wall 2.

In a variant which is not represented, the base 3 is housed in a counterbore made in the wall 2, such that when the transducer 1 is in position on said wall, the upper face thereof is substantially coplanar with said wall.

In another variant which is not represented, the transducer 1 is not visible, being incorporated in the wall 2.

The frame 5 is made of a rigid material insensitive to the magnetic field, being in particular, as specified before, made of moulded plastic material.

In the lower portion, the frame 5 is equipped with a fastening portion 6 on the base 3. This portion 6 has a configuration which is complementary to the relief 4 of the base 3. In this case, it is cylindrical and provided with an internal thread 42.

The frame 5 has a generally U-shaped section. It can be of another shape provided that it includes a housing for receiving the magnetic mass 11.

This housing comprises a flat bottom 7 equipped with a hollow cylindrical mandrel 8 with a circular base. The mandrel 8 is in a central position on the bottom 7 and it is fastened on the latter; advantageously it is integral with the bottom 7, for example by moulding or machining; alternatively, it is glued or welded.

A coil 9 is wound around the mandrel 8. This coil 9 is formed from a metal wire, in particular copper.

The mandrel 8 equipped with the coil 9 is inserted into an air gap 10 of a complementary shape formed in a magnetic mass 11 in two portions.

A first portion is a cylindrical soft iron core 12 with a circular base of dimensions suitable for being movably inserted, with a minimum clearance, in the lumen of the mandrel 8.

The length of the core 12 is greater than the length of the mandrel 8, such that a portion of said core 12 extends above the open end of the mandrel 8, as shown in FIGS. 1 and 8.

An annular magnet 13, embedded in a metal cylindrical part 14, forms the second portion of the magnetic mass 11. The cylindrical part 14 has dimensions and a shape such that it holds the magnet 13 while capping the core 12.

The magnet 13 is a permanent magnet composed for example of an alloy of neodymium, iron and boron.

The core 12, the cylindrical part 14 and the magnet 13 are coaxial and concentric. Their common axis A is aligned with the centre of the bottom 7. Here, the axis A is materialised by the central longitudinal axis of a cylindrical orifice 15 called decompression orifice extending over the height of the core 12 and crossing the portion of the cylindrical part 14 located above said core.

The outer wall of the core 12 and the inner wall of the lumen of the magnet 13 and the cylindrical part 14 define the air gap 10. In other words, the coil 9 is inserted into the air gap 10 between the consecutive portions 12, 13, 14 constituting the magnetic mass 11, this with minimal clearance.

The magnetic mass 11, formed by the core 12 and the magnet 13 embedded in the cylindrical part 14, is generally disk-shaped with a thickness close to the height of the frame 5.

The portions 12, 13, 14 constituting the magnetic mass 11 are held together by known means, for example by screwing, gluing, welding.

Alternatively, the portions 12, 14 are in one piece and obtained by machining or moulding, the magnet 13 being inserted by force into a housing formed in the portion 14.

The outer walls 16 of the cylindrical part 14 and the inner walls 17 of the frame 5 are parallel to each other, but contactless, thus forming a clearance 18 therebetween. Thus, the magnetic mass 11 is movable relative to the frame 5, thanks to the clearance 18 and to the air gap 10, the mandrel 8 not being fastened to the core 12 and to the coil 9. In other words, the magnetic mass 11 is suspended in the frame 5.

Suspension means 19a, 19b ensure the magnetic mass 11 to be maintained in suspension in the frame 5.

The suspension means 19a, 19b are parallel to each other. They are disposed parallel to the bottom 7 of the frame 5, therefore perpendicular to the axis A when the magnetic mass 11 is in place in said frame. The suspension means 19a, 19b are held, on the one hand, on the inner wall 17 of the frame 5 and, on the other hand, on the cylindrical part 14.

At the cylindrical part 14, the suspension means 19a, 19b pass through the outer wall 16 and extend to the annular magnet 13. The suspension means 19a, 19b are fastened to the frame 5 and to the magnetic mass 11 by means known per se, here by screws 20 being inserted into orifices 51.

The suspension means 19a, 19b thus extend through the entire clearance 18 and they maintain the magnetic mass 11 in suspension relative to the frame 5, by enabling translational movements, alternately in one direction and in the other, with variable amplitudes, of said magnetic mass relative to the mandrel 8, in a direction coinciding with the axis A, as illustrated by the double arrow F in FIG. 8.

According to the represented embodiment, a basic spring 25 is surrounded by an outer U-shaped slot 50 extending between the two second ends 32, 33 thereof while passing through the connecting bridge 29.

In particular, the inner slot 28 of a basic spring 25 extends between the two second ends 32, 33 thereof to open into the outer slot 50 of the contiguous basic spring 25 which is disposed opposite to the direction of orientation S1, S2 of said springs.

According to the represented embodiment:
the outer segment 27 is connected to the outer portion 24 only by the second end 33 thereof,
the inner segment 26 is connected to the inner portion 22 only by the second end 32 thereof,
said segments are connected to each other only by the connecting bridge 29.

According to the represented embodiment, the second ends 32, 33 are located radially in vertical alignment with each other.

The segments 26, 27 then have the same angular extent along the axis A, and therefore a similar length, allowing an axial translation not accompanied by an axial rotation.

According to the represented embodiment, the suspension means 19a, 19b are in the general shape of flattened circular rings defining a lumen 21 and generally falling within two planes perpendicular to the axis of symmetry A.

According to the represented embodiment, the suspension means 19a, 19b are located respectively at each of the ends of the magnet 13, so as to maximise the gap therebetween and to avoid, in lateral view, any parasitic non-axial rotational movement of the magnetic mass 11 when the transducer 1 is in use.

According to one embodiment, the suspension means 19a, 19b are made from two cut metal plates.

According to another embodiment, the suspension means 19a, 19b are made of moulded plastic material, said material being capable of being filled with fibres. In particular, they can be integrated into a single moulded piece so as to form a one-piece assembly.

According to another embodiment, the suspension means 19a, 19b are based on cut cardboard.

According to another embodiment, the suspension means 19a, 19b are made of composite material.

As shown in FIG. 1, a protective cover 38 caps the active portion of the transducer 1.

The fastening of the suspension means 19a, 19b respectively on the frame 5 and the magnetic mass 11 is done here by screws 20.

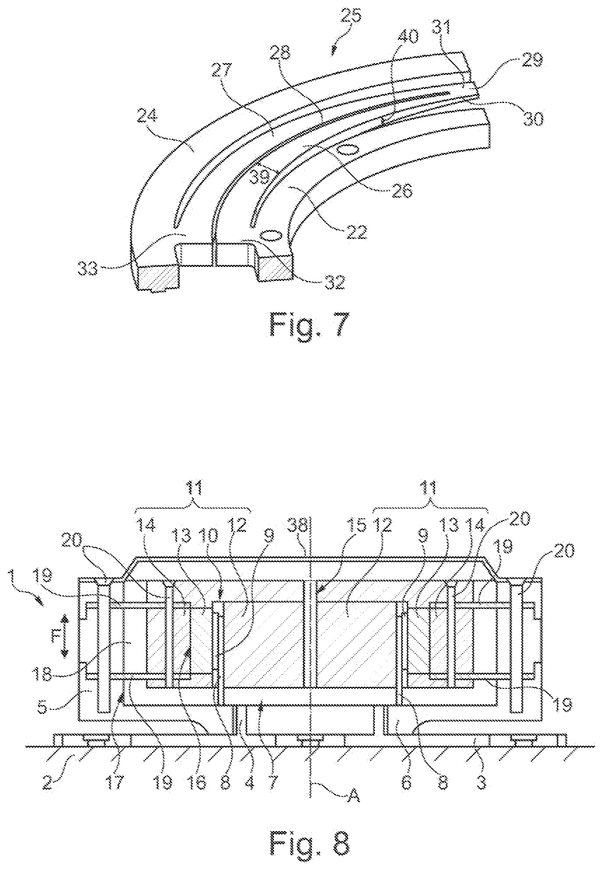

According to the embodiment represented in FIG. 7, the suspension means 19a, 19b being in particular made of moulded plastic material, the segments 26, 27 have a thickness 40 which tapers as moving towards the bridge 29.

According to the embodiment represented in FIG. 7, the suspension means 19a, 19b being in particular made of moulded plastic material, the segments 26, 27 have a width 39 which tapers as moving towards the bridge 29.

By applying one and/or the other of these characteristics, the basic springs 25 are given an evolutionary stiffness allowing transmitting, with maximum efficiency, the force of inertia of the magnetic mass 11 on the wall 2 to be vibrated.

Furthermore, such a design prevents the springs 25 from behaving as auxiliary resonators absorbing, at their resonance, the vibrations of the mass 11; indeed, such a behaviour would prevent the transmission of the inertial force at the resonant frequency.

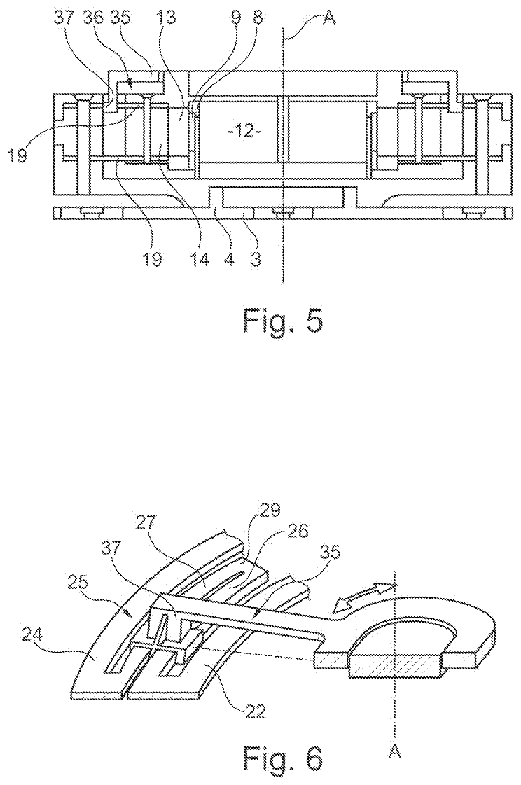

According to the embodiment represented in FIGS. 4 to 6, the transducer 1 further comprises a ring 35 for adjusting the stiffness of at least one suspension means 19a, 19b, said ring being mounted in rotation on the magnetic mass 11, said ring comprising a plurality of sliders 37 each bearing on the basic springs 25 to define the length of lever arm of the segments 26, 27 and the resulting stiffness.

With such an arrangement, it is possible to provide for the use of a transducer 1 common to various applications requiring different stiffnesses of the suspension means 19a, 19b.

According to one embodiment, a ring 35 made of a rigid material, for example a polymer, is used.

According to the represented embodiment, the ring 35 is provided, on the face 36 thereof which is oriented in the direction of the suspension means 19a, 19b, with several sliders 37 each bearing on a respective spring 25.

According to the represented embodiment, the sliders 37 are inserted via a sliding protrusion into the slots 28, 50.

According to the position of the sliders 37, the basic springs 25 are stiffened more or less, by adjusting the length of lever arm of each of the segments 26, 27; in order to adjust the position of sliders 37, simply rotate the ring 35 clockwise or counterclockwise.

Finally, a trim element of a motor vehicle compartment provided with at least one transducer 1 as previously described is described, said element comprising:

a wall 2 for fastening said transducer,

a base 3 fastened on said wall, the frame 5 being associated to said base—in particular by reciprocal threads 41, 42 respectively provided on said base and said frame.

What is claimed is:

1. An electrodynamic transducer comprising:
a fixed portion comprising a frame provided with a hollow mandrel fitting into a cylindrical envelope extending along an axis of symmetry, a coil being wound around the hollow mandrel,
a movable portion comprising a magnetic mass, the magnetic mass comprising:
a cylindrical metal part defining a housing,
an annular permanent magnet fastened into the cylindrical part and surrounding the coil,
a cylindrical soft-iron core fastened on the cylindrical metal part and being inserted inside the hollow mandrel, the coil being positioned between the annular permanent magnet and the core,
the magnetic mass being connected to the frame via a first axially offset suspension and a second axially offset suspension means allowing an axial translational displacement of the mass with respect to the frame, the transducer wherein:
each of the first axially offset suspension and the second axially offset suspension has a plurality of springs, the springs being disposed according to rotational symmetry about the axis of symmetry (A), between inner portions of the first axially offset suspension and the second axially offset suspension which are secured to the magnetic mass and outer portions of the first axially offset suspension and the second axially offset suspension which are secured to the frame, the inner and outer portions being movable relative to each other in axial translation via the springs,
the springs comprise an inner segment and an outer segment, the segments extending along two concentric circular arcs about the axis and being separated by a slot, the segments having two respective first ends connected via a connecting bridge, the inner segment being secured via an inner second end to the inner portion and the outer segment having another an outer second end which is secured to the outer portion, the path going from the inner and outer second ends to the connecting bridge defining a direction of orientation (S1, S2) of the springs,
the direction of orientation (S1) of the basic springs of the first suspension means is opposite to that (S2) of the basic springs of the second suspension means, each of the suspension means blocks axial rotation of the other of the suspension means.

2. The transducer according to claim 1, wherein at least one of the inner and outer portions is annular.

3. The transducer according to claim 1, wherein at least one spring is a basic spring and is surrounded by an outer slot extending between the inner second end and the outer second end while passing through the connecting bridge.

4. The transducer according to claim 3, wherein the inner slot of the basic spring extends between the inner second end and the outer second end to open into the outer slot of the contiguous basic spring which is disposed opposite to the direction of orientation (S1, S2) of the springs.

5. The transducer according to claim 1, wherein:
the outer segment is connected to the outer portion only by the outer second end,
the inner segment is connected to the inner portion only by the inner second end, and
the outer segment and the inner segment are connected to each other only by the connecting bridge.

6. The transducer according to claim 1, wherein the inner second end and the outer second end are located radially in vertical alignment with each other.

7. The transducer according to claim 1, wherein the first and second axially offset suspension are in the general shape of flattened circular rings defining a lumen and generally falling within two planes perpendicular to the axis of symmetry (A).

8. The transducer according to claim 1, wherein the first and second axially offset suspension are located respectively at each of the ends of the annular permanent magnet.

9. The transducer according to claim 1, wherein the first and second axially offset suspension are made from either metal, plastic, cardboard or a composite.

10. The transducer according to claim 1, wherein the segments have a thickness which tapers as moving towards the bridge.

11. The transducer according to claim 1, wherein the inner and outer segments have a width which tapers as moving towards the bridge.

12. The transducer according to claim 1, wherein it further comprises a ring for adjusting the stiffness of at least one suspension, the ring being mounted in rotation on the magnetic mass, the ring comprising a plurality of sliders each bearing on the basic springs to define the length of lever arm of the inner and outer segments and the resulting stiffness.

13. A trim element of a motor vehicle compartment provided with at least one transducer according to claim 1, the trim element comprising:
a wall for fastening the transducer,
a base fastened on the wall; and the frame being connected to the base.
